(19) United States
(12) Patent Application Publication
(10) Pub. No.: US 2011/0220408 A1
(43) Pub. Date: Sep. 15, 2011

(54) Electrode and connector attachments for a cylindrical glass fiber wire lead

(76) Inventors: Robert G. Walsh, Lakeville, MN (US); Paul A. Lovoi, Saratoga, CA (US); Jin Shimada, Grantsburg, WI (US); Kimberly Anderson, Eagan, MN (US)

(21) Appl. No.: 12/660,344

(22) Filed: Feb. 23, 2010

Related U.S. Application Data
(60) Provisional application No. 61/208,216, filed on Feb. 23, 2009.

(51) Int. Cl. H02G 15/02

(52) U.S. Cl. 174/75 R

(57) ABSTRACT

A cardiac pacemaker or other CRT device has one or more fine wire leads to the heart. Formed of a glass, silica, sapphire or crystalline quartz fiber with a metal coating, a unipolar lead can have an outer diameter as small as about 300 microns or even smaller. The metal buffer coating may be deposited directly on the glass/silica fiber, or upon an intermediate layer between the glass/silica fiber and metal, consisting of carbon and/or polymer. The resulting metallized glass/silica fibers are extremely durable, can be bent through small radii and will not fatigue even from millions of iterations of flexing. Bipolar fine wire leads can include several insulated metallized glass/silica fibers residing side by side, or can be coaxial with two or more insulated metal conductive paths. An outer protective sheath of a flexible polymer material can be included. The fine wire lead incorporates a thin metal conductor, which poses unique challenges for attachment to standardized connectors, as well as stimulation electrodes. The present invention describes means and materials for creating robust and durable electrically conductive connections between the fine wire lead body and a proximal standardized connector and distal ring and tip electrodes.

This application claims benefit of provisional application No. 61/208,216, filed Feb. 23, 2009.

### BACKGROUND OF THE INVENTION

This invention concerns wiring for electrostimulation and sensing devices such as cardiac pacemakers, ICD and CRT devices, and neurostimulation devices, and in particular encompasses an improved implantable fine wire lead for such devices, a lead of very small diameter and capable of repeated cycles of bending without fatigue or failure. The term therapeutic electrostimulation device (or similar) as used herein is intended to refer to all such implantable stimulation and/or sensing devices that employ wire leads. A fine wire lead consists of several key components, including a lead body, a proximal several key components, including a lead body, a proximal connector, and one or more distal electrodes, which are affixed to the lead body. A key aspect to fabrication of a robust and durable glass or silica fiber-based fine wire lead is the manner in which the proximal connector is attached to the lead body, and the one or more electrodes to the distal end of the lead. This invention is directed towards defining the means and materials by which the connector and electrodes are attached to a glass fiber fine wire lead body.

Therapeutic pacing has become a well-tested and effective means of maintaining heart function for patients with various heart conditions. Generally, pacing is done from a control unit placed under but near the skin surface for access and communications with the physician controller when needed. Leads are routed from the controller to the heart probes to provide power for pacing and data from the probes to the controller. Probes are generally routed into the heart through the right, low pressure, side of the heart. Access through the heart wall into the high-pressure left ventricle has not generally been successful. For access to the left side of the heart, lead wires are instead routed from the right side of the heart through the coronary sinus and into veins draining the left side of the heart. This access path has several drawbacks; the placement of the probes is limited to areas covered by veins, leads occlude a significant fraction of the vein cross section and the number of probes is limited to 1 or 2.

Over 650,000 pacemakers are implanted in patients annually worldwide, including over 280,000 in the United States. Over 3.5 million people in the developed world have implanted pacemakers. Another approximately 900,000 have an ICD or CRT device. The pacemakers involve an average of about 1.4 implanted conductive leads, and the ICD and CRT devices use on average about 2.5 leads. These leads are necessarily implanted through tortuous pathways in the hostile environment of the human body. They are subjected to repeated flexing due to beating of the heart and the muscular movements associated with that beating, and also due to other movements in the upper body of the patient, movements that involve the pathway from the pacemaker to the heart. This can subject the implanted leads, at a series of points along their length, through tens of millions of iterations per year of flexing and unflexing, hundreds of millions over a desired lead lifetime. Previously available wire leads have not withstood these repeated flexings over long periods of time, and many have experienced failure due to the fatigue of repeated bending.

Neurostimulation refers to a therapy in which low voltage electrical stimulation is delivered to the spinal cord or targeted peripheral nerve in order to block neurosensation. Neurostimulation has application for numerous debilitating conditions, including treatment-resistant depression, epilepsy, gastroparesis, hearing loss, incontinence, chronic, untreatable pain, Parkinson's disease, essential tremor and dystonia. Other applications where neurostimulation holds promise include Alzheimer's disease, blindness, chronic migraines, morbid obesity, obsessive-compulsive disorder, paralysis, sleep apnea, stroke, and severe tinnitus.

Today's pacing leads manufactured by St. Jude, Medtronic, and Boston Scientific are typically referred to as multifilar, consisting of two or more wire coils that are wound in parallel together around a central axis in a spiral manner. This construction technique helps to reduce impedance in the conductor, and builds redundancy into the lead in case of breakage. The filar winding changes the overall stress vector in the conductor body from a bending stress in a straight wire to a torsion stress in a curved cylindrical wire perpendicular to lead axis. A straight wire can be put in overall tension, leading to fatigue failure, whereas a filar wound cannot. However, the bulk of the wire and the need to coil or twist the wires to reduce stress, limit the ability to produce smaller diameter leads.

Modern day pacemakers are capable of responding to changes in physical exertion level of patients. To accomplish this, artificial sensors are implanted which enable a feedback loop for adjusting pacemaker stimulation algorithms. As a result of these sensors, improved exertional tolerance can be achieved. Generally, sensors transmit signals through an electrical conductor which may be synonymous with pacemaker leads that enable cardiac electrostimulation. In fact, the pacemaker electrodes can serve the dual functions of stimulation and sensing.

Definition of a robust and durable glass fiber fine wire pacing lead was the subject of copending U.S. patent application Ser. No. 12/156,129, filed May 28, 2008, incorporated herein by reference in its entirety and assigned to the assignee of this invention. It is the object of the present invention described herein to address an important structural detail of the fine wire glass fiber lead described in the previous referenced patent application. That detail refers to the means and materials by which a proximal connector and one or more distal electrodes are attached to the glass fiber fine wire lead body.

### SUMMARY OF THE INVENTION

As discussed in the referenced application Ser. No. 12/156,129, considerable flexibility exists for the construction of a robust and durable electrically conductive small diameter lead body for therapeutic electrostimulation. This flexibility is considered advantageous, as an additional set of requirements must be met for achieving a robust and stable attachment of proximal and distal terminals to the lead body. This invention is directed primarily of the means and materials for creating an attachment between a connector and the proximal end of the lead body, as well as one or more electrodes to the distal end of the lead body. The primary technical challenge met in this disclosure is obtaining a stable attachment of the connector and electrodes to one or more thin metal electrical conductors in or on the lead body.

In a first embodiment of the present invention, a glass or silica fine wire lead body such as described above is attached to a standard male-type IS-1 connector, well known in this field. Such a connector has a low profile, can be bipolar, and employs a setscrew for attachment to a standardized female-type IS-1 connector receptacle on the body of the pacer unit or can. In this first iteration, the proximal end of one lead body is positioned within the male-type IS-1 connector in such a way that the metal conductor of the lead body is in direct approximation to the proximal pin electrode of the male-type IS-1 connector. A stable electrical connection is then achieved by potting the end of the lead body into an internal hollow portion of the pin electrode, or alternatively to the distal end of a solid pin electrode, by use of electrically conductive adhesive, or solder. Alternatively, metal or metal alloy may be heated to a molten state and introduced into the pin electrode interior hollow space containing the proximal end of the lead body or at the point of attachment of the distal aspect of the pin electrode with the proximal end of the lead body. A secondary step of potting silicon or other dielectric material in or around the connection site between the pin electrode and the lead body provides electrical insulation.

A similar series of steps can also be followed for creating a stable electrical connection between the proximal end of a second glass or silica fiber lead body and the ring electrode of the male-type IS-1 connector in a bipolar electrostimulation lead. A polymeric stress relief may be added to an area adjacent to the distal end of the male-type IS-1 connector in order to avoid creation of a significant stress riser at the site where the lead body or bodies exit the male-type IS-1 connector.

An alternative embodiment for attachment of a lead body to an male-type IS-1 connector employs crimping to establish a stable connection between the pin and ring electrodes of the male-type IS-1 connector, and the proximal terminal ends of lead bodies. In this case, a proximal end of a lead body is inserted into a male-type IS-1 connector in direct approximation with the pin or ring electrode of the connector. A physical force is then applied to crimp the pin or ring electrodes of the male-type IS-1 connector onto the lead body. Alternatively, a continuous short section of a thin metal tube is initially crimped onto the proximal end of a lead fiber, which is then inserted into the male-type IS-1 connector. Or alternately, a non-continuous short section of a thin metal tube, appearing as a C in cross section, i.e. a slit tube, is first positioned on the end of the lead body. A physical crimp force is then applied to partially or completely close the slitted tube over the lead body, which is then preferably followed by use of laser to weld the tube closed. For these latter two cases employing crimping force, a potting material using electrically conductive adhesive or solder, or molten metal, may still be used to create a robust and stable electrical conductor, such as described above.

For a bipolar lead design, one lead body is made to pass through the hollow central area of the ring electrode to make electrical contact with the pin electrode of the male-type IS-1 connector. The small outer diameter of the lead body, as compared to the internal diameter of the ring electrode, makes it quite easy to accomplish this passage. Importantly, care must be taken to insure that the lead body attached to the male-type IS-1 connector pin electrode is electrically insulated distal to the pin electrode connection, in order to avoid electrical connection with the ring electrode, thus creating a short-circuit path to the ring electrode. Likewise, the second lead body, which is electrically attached to the ring electrode, must also be completely insulated to avoid creation of a short-circuit path to the first lead body or the pin electrode on the male-type IS-1 connector.

In a further embodiment, a polymer or metal detent or screw feature is first attached to the proximal end of the lead body, prior to attachment to the male-type IS-1 connector. This step may be accomplished before or after the step of metallizing the lead body. If done before metallization of the lead body, then the detent or screw feature is coated with metal during the same process of metallizing the lead body surface. If done after metallization, then the polymer or metal detent or screw feature is first rendered electrically conductive. In the case of polymer, the material may be made electrically conductive by coating with a metal or metal alloy, similar to what is described above. The polymer feature would require coating with metal on the surface facing the lead body, as well as on the surface facing away from the lead body. Alternatively, the polymer itself may be fabricated out of electrically conductive material, or fashioned to contain an electrically conductive filler, such as a metal or metal alloy solids, such as a metal ring, or fine-particle suspension. If the feature is made out of metal, then electrical conductivity can be optimized through the proper choice of metal, such as silver, gold, or platinum, or metal alloy such as platinum-iridium or MP35N.

In one embodiment, a tight metallic wire coil is applied to or near the end of a lead body with laser welding to stabilize the coil. This coil may be applied directly to the glass fiber, or as an overlayment to the thin walled-tube or slitted tube described above. If applied to the thin-walled or slitted tube, the coil can be extended away from the tube as a means of stabilizing the coil and thin-walled or slitted tube. The coil may cover a portion or all the end of the lead body as well as the thin-walled or slitted tube, if so desired.

Attachment of the polymer or metal feature or detent to the lead body is by way of one or more of the means as described earlier, namely by potting with electrically conductive adhesive or solder, or with molten metal or metal alloy or via laser welding. Alternatively, if the feature is attached to the lead body prior to metallizing the lead body, then a conventional non-electrically conductive adhesive will suffice. Alternatively, the feature may be bonded to the proximal end of the lead body by employing heat, via laser, ultrasonic welding, or other means of creating a robust bond between materials.

The surface contour of the polymer or metal feature or detent described above is designed so as to match an opposite pattern set in the pin or ring electrodes of the male-type IS-1 connector. This pattern may be a screw or other detent means, exemplified by a bayonet style connection. In addition, potting materials such as described above may be used to create a permanent bond between the detent or screw feature on the lead body and the matching opposite pattern in the pin or ring electrodes of the male-type IS-1 connector. In addition, the profile of the detent or screw feature can be made small enough so as to allow passage of the proximal end of a lead body through the hollow central opening of a ring electrode in order to connect with the pin electrode.

The means and materials described for creating a robust and stable electrical connection between the proximal end of a lead body and a standard male-type IS-1 connection can be adapted easily for attachment to a male-type IS-4 connector, or any other standard or non-standard connector.

In addition, the same means and materials can be used for creating a stable electrical connection between the distal end of the lead body, and tip and ring electrodes which provide electrical stimulation to, or sensing from, adjacent biological tissues.

As indicated previously, various metals or metal alloys may be suitable for employment as a permanently deposited electrical conductor for the fine wire lead. Idealized properties include excellent electrical conductivity with low electrical resistance, resistance to corrosion, or heat, which may be employed at various steps during the fine wire lead manufacturing process. Estimated metal cross sectional area for a desired electrical resistance may be determined theoretically from the following relationship:

R=ρ*(1/A),

where R=resistance (ohms), ρ=metal resistivity (ohms-cm), 1=conductor length (cm) and A=cross sectional area of conductor. Thus, desired resistance is equal to the product of resistivity and the quotient of length and cross-sectional area. For some applications of the fine wire lead of this invention, desired electrical resistance may be on the order of 50 ohms. Using silver as an example, resistivity is 1.63×10⁻⁶ ohms-cm. Thus, a silver conductor of approximately 1000 nm thickness would provide the desired electrical resistance for a fine lead wire of approximately 0.015 cm diameter and 80 cm length.

If so desired, the thickness of the metal coating may be increased or decreased at the proximal and distal ends of the lead body in preparation for attachment to pin or ring electrodes of the male-type IS-1 connector, or to the tip or ring electrodes of the distal end of the glass or silica fine wire lead. This may be accomplished by employing masks in the metallization process to define areas of the lead intended to receive more or less metal coating. This may have advantage for making robust electrical connections. As one example, it may be desirable to increase the thickness of metal coating at the distal and proximal ends of the lead body in order to insure creation of a stable and robust electrical connection with electrodes. Gradations in metal thickness may be employed, involving abrupt, or gradual thickness changes along the length of the lead termini, depending on the type of mask employed.

Any portion of the lead body that is not protected from water or water vapor exposure, such as in normal atmosphere or within the body, will rapidly degrade in strength due to the formation of surface cracks. Thus, the connections between the proximal end of the lead body and male-type IS-1 connector, and the distal end of the lead body with tip and ring electrodes must be hermitically sealed. Hermetically sealing the processed ends of the lead body will ensure that it remain rigid and protected thus preserving the very high strength and fatigue resistance of the flexible portion of the lead. One approach for hermetic sealing is by the use of an inorganic, high-temperature dielectric, glass or silica, which can be fused together with a similar dielectric. Hermeticity can be achieved whether the device is in the form of a coax or individual fibers cabled together, as long as an impervious surface seal is applied. This sealed approach can also be used with industry standard conductors such as a male-type IS-1 making the lead compatible with most manufactures' pacing products.

The distal end of the glass/silica fine wire lead of this invention is also compatible with anchoring systems for stabilizing the fiber lead against unwanted migration within the vasculature or heart. Such anchoring systems can consist of expandable/retractable stents attached to the lead, or helical, wavy, angled, corkscrew, J-hook or expandable loop-type extensions attached to the lead, that take on the desired anchoring shape after delivery of the lead from within a delivery catheter.

The fine wire leads of this invention, which incorporate male-type IS-1 connectors and distal lead electrodes can be installed using delivery devices. A steerable catheter for example, can be used and then removed when the leads are properly deployed in the proper anatomical positions.

It is among the objects of the invention to improve the durability, lifetime flexibility and versatility of wire leads for pacemakers, ICDs, CRTs and other cardiac pulse generators, as well as electrostimulation or sensing leads for other therapeutic purposes within the body. In part, this is accomplished by the invention described here, involving means and materials for achieving a robust and durable attachment of a male-type IS-1 connector to the proximal terminus of a glass/silica lead body, as well as ring and tip electrodes to the distal terminus of a glass/silica lead body. These and other objects, advantages and features of the invention will be apparent from the following description of preferred embodiments, considered along with the accompanying drawings.

### DESCRIPTION OF THE DRAWINGS

FIG. 1 is a schematic drawing in perspective showing one embodiment of an implantable fine wire lead for a cardiac pulse generator such as a pacemaker, with exposed metal conductor.

FIG. 2 is a schematic drawing in perspective showing a slitted metal tube segment.

FIG. 3 is a schematic drawing in perspective of a fine wire lead body segment with exposed metal conductor upon which a slitted metal tube segment is positioned.

FIG. 4 is a schematic drawing in perspective of a ring electrode positioned over a slitted metal tube segment on a fine wire lead body.

FIG. 5 is a schematic drawing in perspective of a hollow ring electrode through which pass two separate lead bodies, one of which makes electrical contact with the ring electrode.

FIG. 6 is a schematic drawing in cross section of two lead bodies positioned inside a ring electrode, one lead body making electrical contact with the ring electrode.

FIG. 7 is a schematic drawing in perspective to two lead bodies terminating in a tip electrode, in which one lead body makes electrical contact with the tip electrode.

FIG. 8 is a schematic drawing in cross section of two lead bodies positioned inside a tip electrode, one lead body making electrical contact with the tip electrode.

FIG. 9 is a schematic drawing in perspective of two fine wire lead segments, one with insulation removed, with optional twisting of the fine wire leads.

FIG. 10 is a schematic drawing in perspective of two fine wire lead body segments, one with exposed metal conductor, upon which a slitted or non-slitted metal tube segment is positioned.

FIG. 11 is a similar view showing a laser weld line along a slitted solid tube or a mesh tube segment overlying an exposed metal segment of a fine wire lead body.

FIG. 12 is a schematic drawing in perspective of another embodiment of a hollow ring electrode through which pass two separate lead bodies with slitted tube, one lead of which makes electrical contact with the ring electrode.

FIG. 13 is a schematic drawing in perspective of another embodiment of a mesh ring electrode through which pass two separate lead bodies with slitted tube, one lead of which makes electrical contact with the mesh ring electrode.

FIG. 14 is a schematic drawing in perspective of another embodiment of slitted metal tube into which terminate two separate lead bodies, one lead body of which makes electrical contact with the slitted tube.

FIG. 15 is a schematic drawing of two lead bodies with exposed metal conductor on one or both lead bodies to maximize contact with tissue.

FIG. 16 is a schematic drawing in perspective of another embodiment of a solid tip electrode into which pass two separate lead bodies with slitted metal tube, one lead of which makes electrical contact with the tip electrode via the slitted tube.

FIG. 17 is a similar view showing a mesh-type tip electrode.

FIG. 18 is a schematic drawing in perspective of a bipolar lead consisting of two unipolar lead bodies, one of which terminates with electrical connection via a slitted metal tube to a ring electrode and the other terminates with electrical connection via a slitted metal tube to a tip electrode.

FIG. 19 is a similar view with detail on the slitted tube, that is, the weld pin segment.

FIG. 20 is a schematic drawing in perspective of a slitted tube overlying an exposed metallized lead body surface, with depiction of a laser weld line.

FIG. 21 is a schematic drawing in perspective of an electrode overlying a slitted tube segment, showing laser welding of an electrode to the tube segment.

FIG. 22 is a schematic drawing in perspective showing an extended slitted tube segment, beyond the length of an overlying ring electrode.

FIG. 23 is a schematic drawing in perspective showing polymer insulation injection or flow ports.

FIG. 24 is a sectional view showing a polymer detent or screw feature attached to a fine wire lead body.

FIG. 25 is a schematic drawing in perspective showing another embodiment of a polymer or metal feature attached to a fine wire lead body.

FIG. 26 is a schematic drawing in perspective showing a conductive wire coil overlying a polymer or metal feature on a lead body, stabilized by welding.

FIG. 27 is a schematic drawing of a bipolar male-type IS-1 connector encompassing two silica or glass fine wire lead bodies, making electrical connection to separate terminal electrodes.

FIG. 28 shows schematically a portion of a male-type IS-1 connector secured in electrical contact with the end of a fine wire lead.

FIG. 29 shows schematically a portion of a bipolar connector such as the connector 99 of FIG. 27 and showing one of the pair of fine wire leads as electrically connected to a ring electrode via a split tube.

### DESCRIPTION OF PREFERRED EMBODIMENTS

The invention encompasses attachment of proximal electrically conductive connectors and distal electrodes on all implanted fine wire leads, but is illustrated in the context of a cardiac pulsing device. Typically, a pacemaker is implanted just under the skin and on the left side of the chest, near the shoulder. The heart is protected beneath the ribs, and the pacemaker leads follow a somewhat tortuous path from the pacemaker under the clavicle and along the ribs down to the heart.

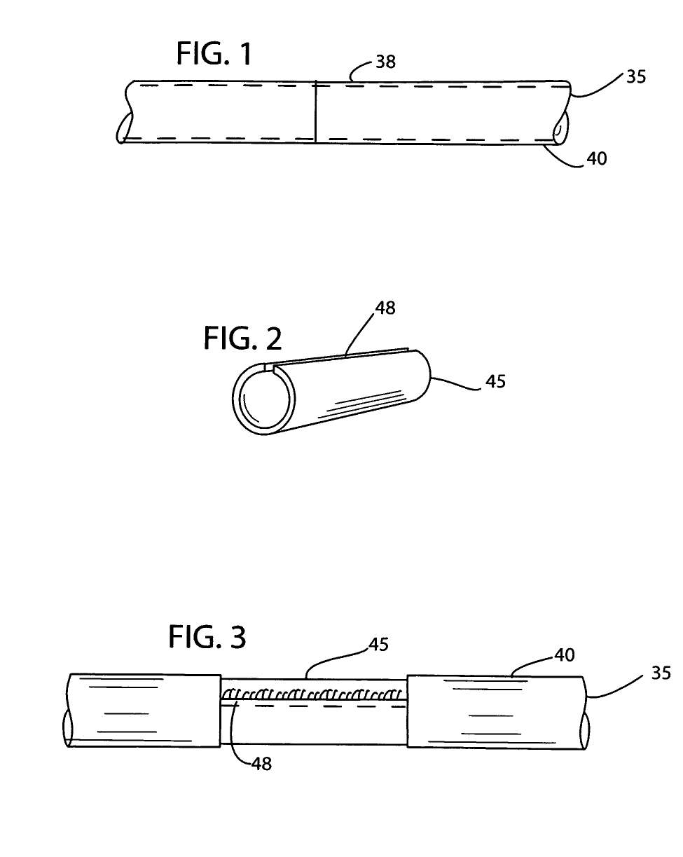

FIG. 1 represents a schematic drawing of a fine wire lead 35 with protective outer polymer coating 40 removed from a portion of the lead, revealing a conductive metal buffer 38 of thickness up to 8000 Angstroms, affixed to an underlying drawn glass fiber core. The exposed conductive metal buffer provides for electrical connection with connectors or electrodes. The length of the exposed conductive metal buffer is variable, dependent on the type of connection made with connectors or electrodes.

FIG. 2 represents a slitted metal tube 45, fabricated of an electrically conductive metal such as platinum or metal alloys such as platinum-iridium, with a longitudinal slit 48. The slit allows for variable diameter of the tube. While platinum and platinum-iridium alloy are exemplary of the invention, other electrically conductive metals and metal alloys can also be employed.

FIG. 3 represents an implantable fine wire lead 35 with a portion of protective outer polymer coating 40 removed to reveal the underlying conductive metal buffer. A slitted metal tube 45 is then positioned over the conductive metal buffer 38 (seen in FIG. 1) and in direct contact with the conductive metal buffer. The length of the slitted metal tube 45 is equal to or less than the length of the exposed conductive metal buffer, and the slitted tube diameter can be adjusted by increasing or decreasing the size of the slit 48. The diameter of the slitted metal tube 45 is adjusted during the process of positioning it over the conductive metal buffer by applying mechanical force, such as crimping, to give a tight fit between the slitted metal tube 45 and the conductive metal buffer. The tight fit may be enhanced by crimping or other mechanical means, followed by laser welding. The placement of the slit tube 45 at a position between insulator portions 40 typically represents connection structure at the distal end of the fine wire lead, for connection to an electrode pursuant to the invention.

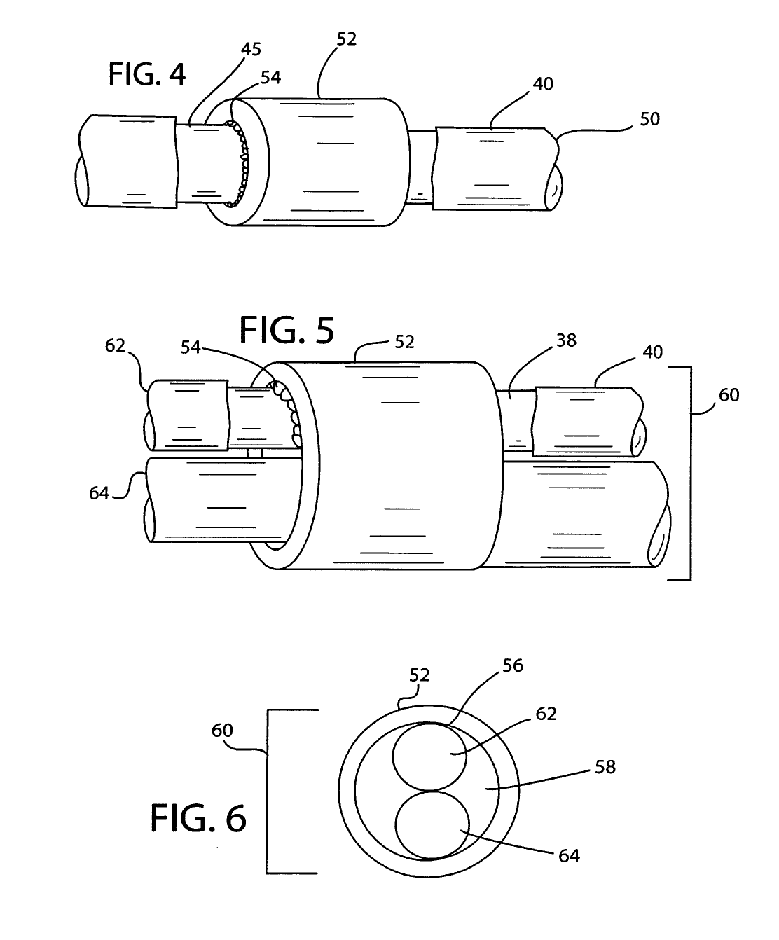

FIG. 4 shows a hollow ring electrode 52 positioned over a slitted metal tube 45 overlying an electrical conductor such as in FIG. 3, on a glass fiber core, near or at the distal end of a unipolar implantable fine wire lead 50. The hollow ring electrode 52 and split ring 45 are positioned over a segment of the fine wire lead over which the protective outer polymer coating 40 does not reside. Also shown is a laser weld 54 providing integral attachment of the ring electrode 52 to the slitted metal tube 45. Other means of integral attachment are possible, including but not limited to electrically conductive adhesive.

FIG. 5 shows an implantable bipolar fine wire lead 60 incorporating a hollow ring electrode 52 through which pass two separate unipolar lead bodies 62 and 64. A first lead body 62, contains a section upon which the protective outer polymer coating 40 does not reside, to enable direct electrical contact between the conductive metal buffer 38 and the hollow ring electrode 52. A laser weld 54, or other form of electrically conductive mechanical stabilization, completes a stable electrical connection between the hollow ring electrode 52 and the lead body 62. A second unipolar lead body 64 with complete protective outer polymer coating passes through the center of the hollow ring electrode 52 without making electrical contact.

FIG. 6 is a cross sectional view of the bipolar fine wire lead 60 shown in FIG. 5, at the level of the hollow ring electrode 52. Two lead bodies 62 and 64 are positioned inside and running through a hollow ring electrode 52. One lead body 62 has an exposed conductive metal buffer at the level of the hollow ring electrode 52 and makes electrical contact 56 with the hollow ring electrode 52, while the other lead body 64, having a complete protective outer polymer coating (not shown) does not make electrical contact with the hollow ring electrode 52. The residual space within the hollow ring electrode excluded by the lead bodies 62 and 64 can be space-filled with an electrical conductive adhesive 58.

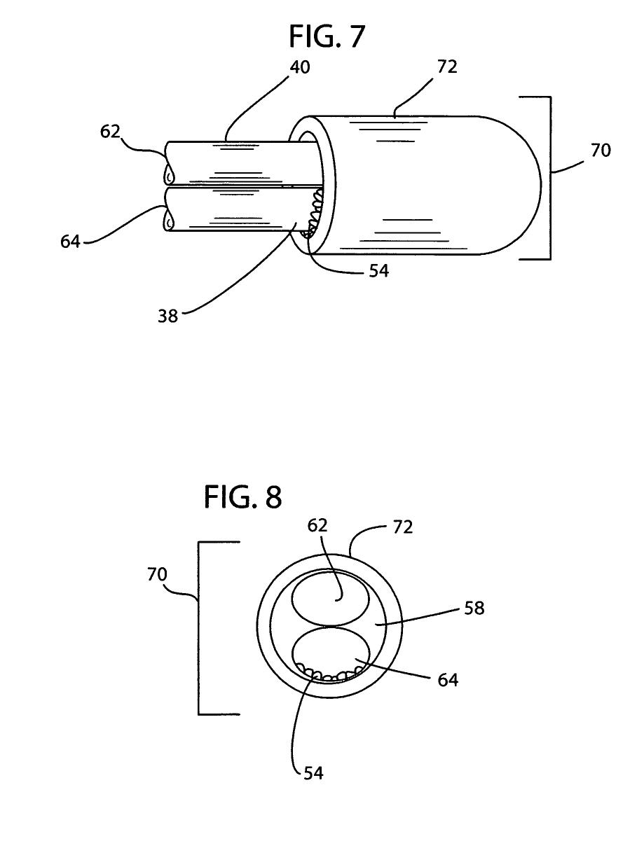

FIG. 7 represents the terminal portion 70 of a bipolar fine wire lead 60 consisting of two lead bodies 62 and 64 terminating within a hollow portion of a tip electrode 72. A first lead body 62 has complete protective outer polymer coating and thus does not makes electrical contact with the tip electrode. A second lead body 64, has a terminal portion of the protective outer polymer coating absent, thus exposing a conductive metal buffer 38. The conductive metal buffer 38 makes electrical contact with the tip electrode 72. A laser weld 54 or other form of electrically conductive mechanical stabilization is used to form an integral electrical connection between lead body 64 and the tip electrode 72.

FIG. 8 is a cross sectional view of the bipolar fine wire lead shown in FIG. 7, at the level of the tip electrode 72. The figure shows two lead bodies 62 and 64 terminating within the tip electrode. One lead body 64 makes electrical contact with the tip electrode 72 by way of a laser weld 54, or other means of creating an integral connection between the lead body 64 and the tip electrode 72. The other lead body 62 is completely insulated with protective outer polymer coating so that it does not make electrical contact with the tip electrode. Instead, this lead body makes electrical contact with the hollow ring electrode 52 shown in previous figures. A space-filling material consisting of an electrically conductive adhesive can be incorporated into the residual space within the hollow portion of the tip electrode 70, excluded by the space occupied by the lead bodies 62 and 64. Note that the two leads 62, 64 may not occupy as much space within the electrode 72 as represented in this schematic view, which shows a limit condition of relative diameters.

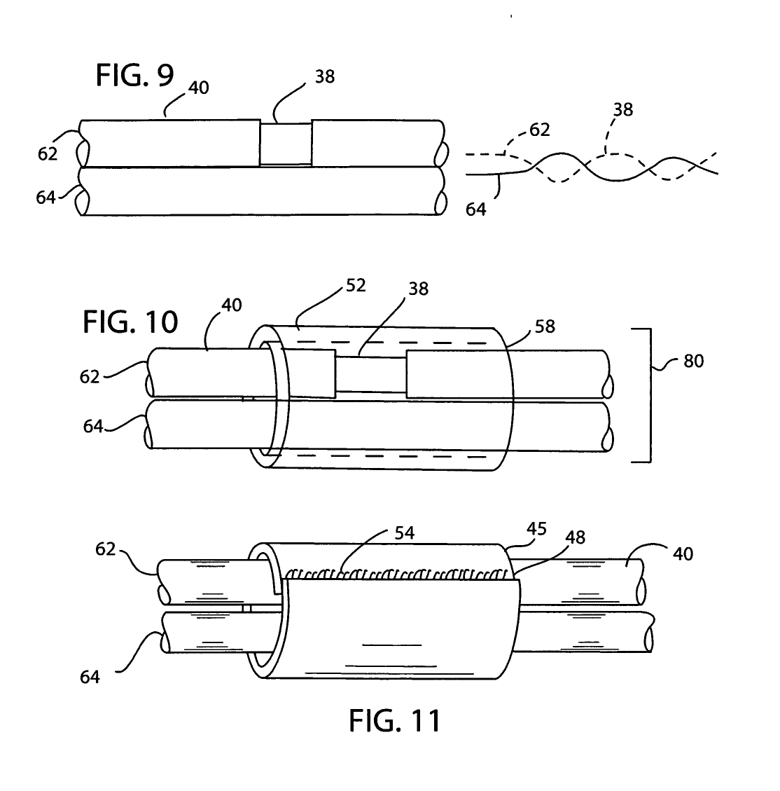

FIG. 9 represents a bipolar fine wire lead composed of two fine wire lead bodies 62 and 64. Lead body 62 has polymer insulation coating 40 removed in one section exposing the conductive metal buffer 38. A side panel of FIG. 9 depicts the two lead body 62 and 64 in an optional twisted configuration, in which a portion of lead body 62 has its protective outer polymer coating 40 removed to expose the conductive metal buffer 38.

FIG. 10 depicts a bipolar fine wire lead 80 incorporating two fine wire lead bodies 62 and 64 upon which a ring electrode, optionally fabricated of platinum-iridium alloy 52, has been positioned. The ring electrode 52 is positioned over an exposed section of conductive metal buffer 38 of lead body 62, where protective outer polymer coating 40 has been removed. Electrical connection between the conductive metal buffer 38 and the ring electrode 52 is insured by incorporating an electrically conductive adhesive, such as silver-filled epoxy 58, into the space within the ring electrode excluded by the two lead bodies 62 and 64.

FIG. 11 depicts a bipolar fine wire lead showing two lead bodies 62 and 64 upon which slitted tube 45 is positioned. Positioning of the slitted tube 45 coincides with removal of protective outer polymer coating 40 from a section of one of the lead bodies (not shown). The slitted tube is shown in a configuration in which the opposing edges of the slitted tube 45 overlap 48, much as might be the case after mechanically crimping the slitted tube 45 against the lead bodies 62 and 64. A laser weld line 54, or other such means of stabilizing the size of the slit, such as electrically conductive adhesive, is placed along the slit. A mesh tube (not shown) can be used as a substitute for the slitted tube 45.

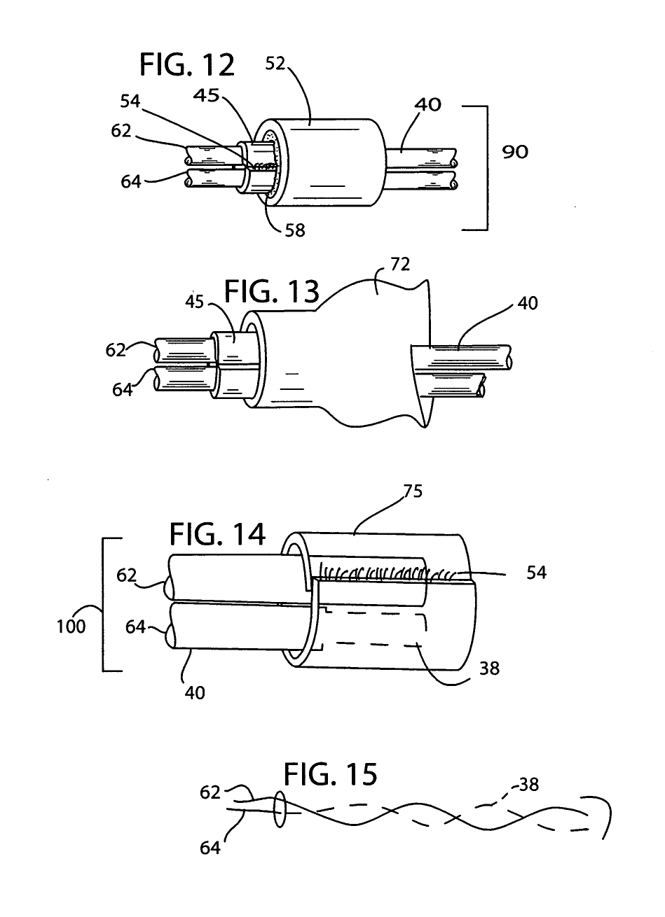

FIG. 12 shows another embodiment of a bipolar fine wire lead 90 depicting a hollow ring electrode 52 through which pass two separate lead bodies 62, 64. One of the lead bodies has a segment of protective outer polymer coating 40 removed to expose the underlying conductive metal buffer. Also incorporated is a slitted solid or mesh tube 45, positioned over the exposed conductive metal buffer so as to make electrical contact between the slitted solid or mesh tube 45 and the exposed conductive metal buffer of one lead body. A laser weld 54 stabilizes the slitted tube over the lead bodies 62 and 64. A hollow ring electrode 52 is shown positioned over the slitted tube 45, and is stabilized in place by way of laser welding, electrically conductive adhesive, or other such means of producing a mechanically stable electrically conductive structure.

FIG. 13 depicts another embodiment of the bipolar fine wire lead of the previous figure in which a mesh ring electrode 72 is substituted for a solid ring electrode 52, and positioned over the slitted solid tube 45. Two lead bodies 62 and 64 pass through the mesh ring electrode, one of which makes electrical contact with the mesh ring electrode 72 in a similar fashion as described for FIG. 12.

FIG. 14 depicts another embodiment of the terminus of a bipolar fine wire lead 100 in which a slitted metal tube 75 is positioned over the ends of two separate lead bodies 62 and 64. Lead body 64 has a segment of conductive metal buffer 38 exposed at its terminus, upon which the protective outer polymer coating 40 does not reside, so that the slitted solid tube 75 will have electrical contact with the conductive metal buffer. Insulation on lead body 62 prevents it from having electrical contact with the slitted solid tube 75. A laser weld 54, or other similar technique as previously described, is used to facilitate integral sizing and connection of the slitted solid tube 75 to the termini of the two lead bodies 62 and 64.

FIG. 15 is a drawing of a bipolar fine wire lead in which two lead bodies 62 and 64, such as depicted in the previous figure, are shown in twisted configuration. The twisting increases the degree of physical contact between the lead bodies 62 and 64 with a slitted solid tube 75 such as shown in the previous figure. Electrical contact is established between the lead body 64, at a terminal section of the lead body where the protective outer polymer coating 40 does not reside and thus exposing a section of conductive metal buffer 38, with the slitted solid tube 75. The area of electrical contact is increased as a result of the twisted configuration of the lead bodies 62 and 64.

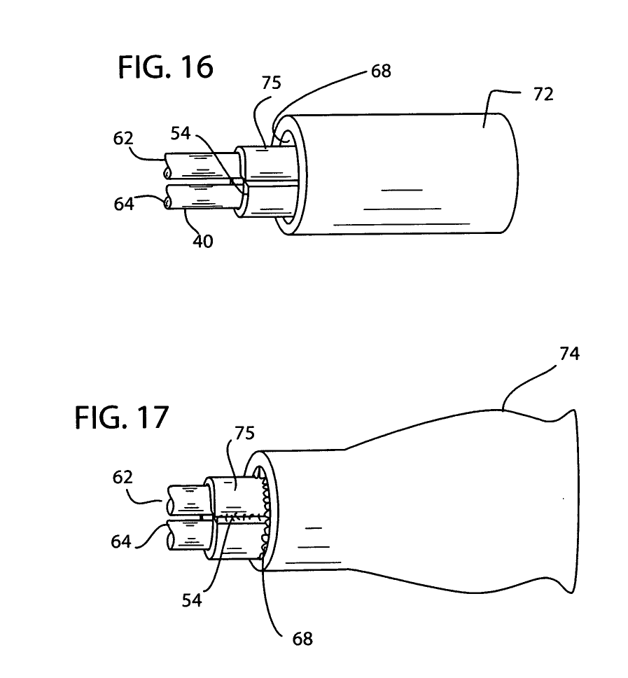

FIG. 16 represents a bipolar fine wire lead consisting of two lead bodies 62 and 64 terminating within a hollow portion of a tip electrode 72. Also incorporated is an intermediate electrically conductive slitted tube 75 between the lead bodies and the tip electrode, providing a means of electrical conductivity, as well as a robust attachment of the tip electrode to the two lead bodies 62 and 64. Laser welds 54 and 68, or other similar technique as previously described, are used to facilitate integral sizing and connection of the slitted solid tube 75 to the termini of the two lead bodies 62 and 64, and the tip electrode 72, respectively. As shown in FIG. 14, one of the lead bodies makes electrical contact with the tip electrode via the slitted solid tube 75.

FIG. 17 is a similar view of a bipolar fine wire lead in which a mesh-type tip electrode 74 is incorporated in place or in conjunction with a solid tip electrode 72. The outer diameter of the mesh electrode is variable and can be expanded to a diameter greater than that of the fine wire lead. Also depicted are lead bodies 62 and 64, one of which makes electrical contact with slitted solid tube 75, which in turn makes electrical contact with the mesh electrode 74. As previously depicted, laser weldings 54 and 68, or other stabilizing techniques such as electrically conductive adhesives, are used to attach and stabilize the various components in a robust and integral construction.

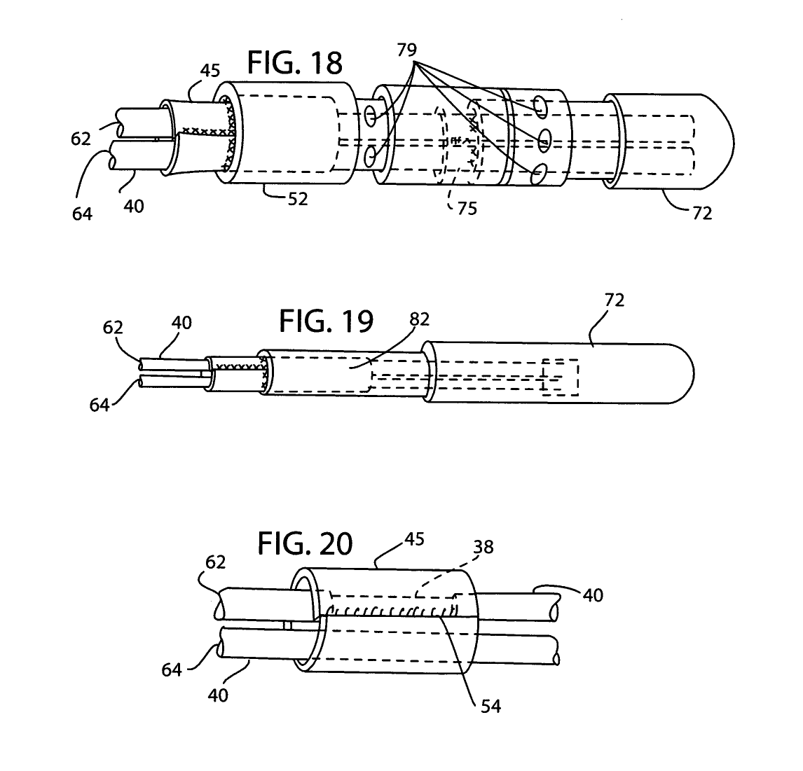

FIG. 18 depicts a bipolar lead consisting of two unipolar lead bodies 62 and 64, one of which makes electrical connection via a slitted metal tube 45 to a ring electrode 52 and the other lead body makes electrical connection via another slitted metal tube 75 to a tip electrode 72. As with other embodiments, laser welds or other electrically conductive means are used to stabilize the lead bodies within the slitted solid tubes 45 and 75, and the slitted solid tubes within the ring and tip electrodes 52 and 72. The figure also shows details of polymer injection ports 79 for space filling around the fine wire lead segments to produce a finalized fine wire lead of uniform profile.

FIG. 19 is another embodiment of a bipolar fine wire lead in which a weld pin 82 is incorporated in fabrication of the tip electrode portion of the lead. The weld pin 82 serves as a strengthening member and prevents premature failure of connections within the terminal portion of the lead. As with other embodiments, the embodiment of this figure incorporates two lead bodies 62 and 64, a slitted tube 75, laser welds and a tip electrode 75.

FIG. 20 is an embodiment of a bipolar fine wire lead similar to, but showing more detail than FIG. 11. FIG. 20 shows two lead bodies 62 and 64 passing through a slitted tube 45. One lead 62 has a portion of insulation 40 removed exposing the underlying conductive metal buffer 38. The slitted tube 45 makes electrical contact with the exposed section of conductive metal buffer 38 on lead body 62. The other lead body 64 has an intact protective outer polymer coating 40 such that it does not electrically contact the slitted tube 45. The figure also depicts areas of laser welding along the slit 54.

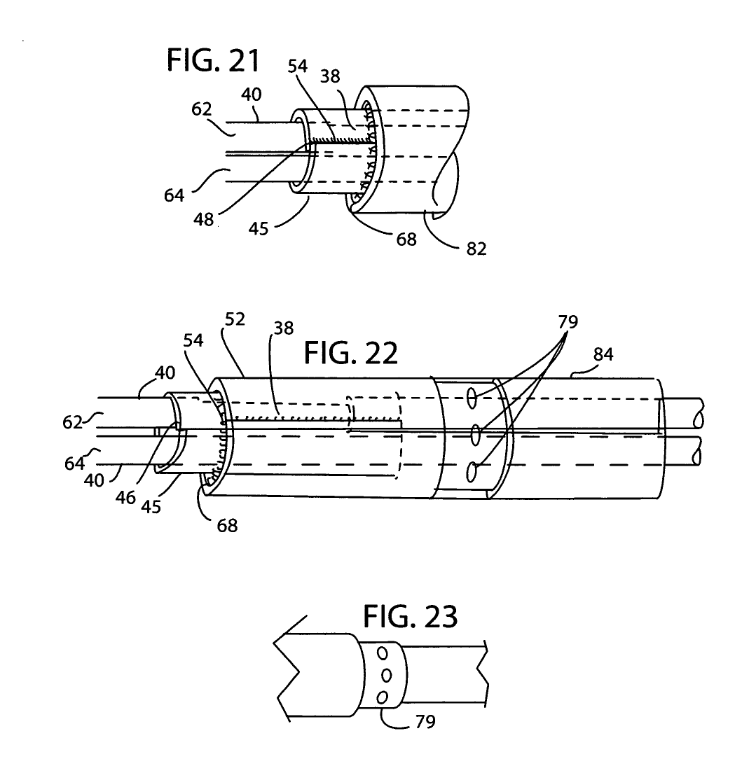

FIG. 21 shows detail of a portion of a bipolar fine wire lead. Shown are two lead bodies 62 and 64 passing through a slitted tube. One lead 62 has a portion of insulation removed exposing an underlying segment of conductive metal buffer 38, so that lead body 62 makes electrically contact with the slitted tube. The other lead body 64 has intact protective outer polymer coating 40 such that it does not electrically contact the slitted tube 45. The figure also depicts areas of laser welding 54 and 68 along the slit 48, and a welding pin 82 overlying the slitted tube 45. A similar arrangement, not shown, can be utilized for the terminal tip electrode.

FIG. 22 shows detail of a portion of a bipolar fine wire lead at the level of the ring electrode 52, incorporating depiction of outer polymer insulation 84 with outer diameter roughly equivalent to that of the ring electrode 52. The outer polymer insulation resides proximal to the ring electrode 52 (not shown), and between the ring electrode 52 and a tip electrode. Depicted are two lead bodies 62 and 64 passing through a slitted tube 45. One lead 62 has a portion of protective outer polymer coating 40 removed to expose a section of conductive metal buffer 38, so that the lead body has electrical contact with the slitted tube 45, which in turn has electrical contact with the ring electrode 52. The other lead body 64 has an intact protective outer polymer coating 40 such that it does not electrically contact the slitted solid tube 334. The figure also depicts areas of laser welding 54 along the slit 48, and a ring electrode 52 overlying the slitted tube 45. In addition, polymer insulation injection or flow ports 79 are depicted. These ports enable injection molding of outer polymer insulation on the lead body.

FIG. 23 shows an extension of the fine wire lead of FIG. 22 towards the terminal end of the lead. This figure is a representation of an additional series of polymer injection ports 79 along the lead body distal to the ring electrode, but proximal to the tip electrode.

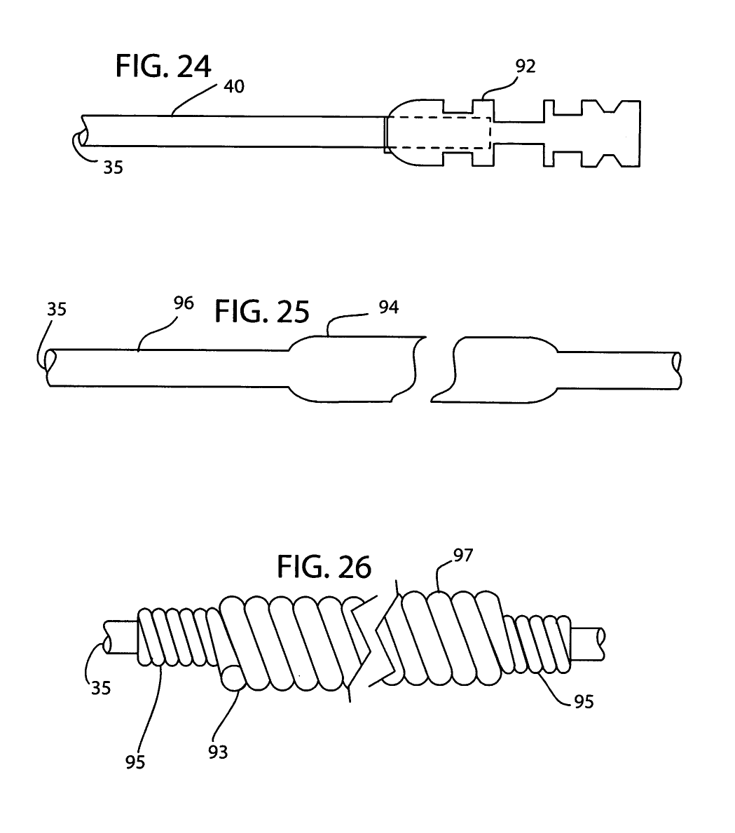

FIG. 24 shows the proximal end of a unipolar fine wire lead 35 in which a detent or screw feature 92 is affixed to an end of a lead body. The shape of this detent or screw feature may have one of many different profiles the intent to maximize the surface area on the outer aspect of the detent. This detent then provides a convenient platform upon which to position a connector or other terminal feature (not shown) on the fine wire lead 35. The detent may be fabricated of metal, insulation polymer, or a combination. If fabricated of metal, the metal can serve as an electrically conductive path for connection to the lead on one hand, and an overlying connector or other terminal feature on the other hand.

FIG. 25 is unipolar fine wire lead 35 showing a different embodiment for a terminal electrode 94 on a lead body 96 in this case, variation in wire or polymer diameter is used to alter flexibility of the lead body 96 at the level of the electrode. The larger the diameter, the less flexible is the segment.

FIG. 26 shows a feature of an embodiment for a fine wire lead 35 in which a conductive wire coil 93 of variable diameter, having one or more small diameter sections 95 and one or more large diameter sections 97, overlies a polymer or metal feature on a lead body 35, and is stabilized by welding. At least one purpose of the coil is in conjunction of sensing by the fine wire lead 35. Another purpose of the coil configuration is similar to that of twisting of unipolar lead bodies as shown in other Figures, to increase surface area of contact and robustness and stability of connections.

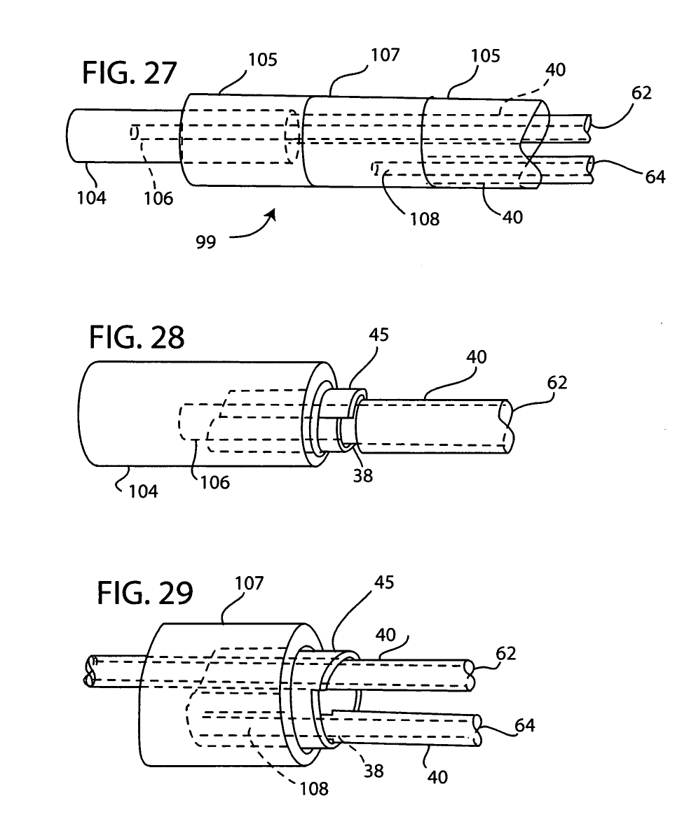

FIG. 27 shows a bipolar male-type IS-1 connector 99 incorporating two independent glass or silica fine wire lead bodies 62 and 64. The lead bodies 62 and 64 are electrically independent, and terminate in electrical connection proximally at the pin electrode 104, and ring electrode 107, respectively. The pin electrode 104 resides at the extreme proximal end of the male-type IS-1 connector, and contains a hollow portion open to the distal aspect of the pin electrode 104, into which the proximal end of one of the lead bodies, 62, is inserted. The portion of the lead body 62 residing within the hollow portion of the pin electrode 104 has protective outer polymer coating 40 removed so that the metalized surface 106 of the lead body 62 makes direct physical contact with the pin electrode 104 so as to create a stable permanent electrical connection. The proximal end of the lead body 62 is stabilized within the pin electrode via laser welding, soldering, electrically conductive adhesive, or other such means. The distal end of the pin electrode resides within an outer electrical insulating polymer sheath 105, defining the outermost diameter of the male-type IS-1 connector. This polymer sheath extends distally and discontinuously along the lead to the distal terminal of the lead. The male-type IS-1 connector incorporates the ring electrode 107 just distal to a section of the outer insulating polymer sheath 105. The ring electrode 107 marks a discontinuity in the outer insulating polymer sheath 105. The outer diameter of the ring electrode and the outer insulating polymer sheath may be approximately equal, but are not necessarily so. For example, the outer diameter of the outer insulating polymer sheath is configured in FIG. 27 to be greater than that of the pin electrode 104. The ring electrode 107 is hollow, allowing one lead body 62 to pass through it without making electrical contact. The second lead body 64 has an exposed metalized glass fiber surface 108, upon which the protective outer polymer coating 40 does not reside, that is affixed to the inner diameter of the hollow ring electrode 107. Fixation of the metal surface of the lead body 64 may be by laser welding, soldering, electrically conductive adhesive or the like, providing electrical conductivity between the lead body 64 and the ring electrode 107.

FIG. 28 represents a portion of a male-type IS-1 connector incorporating a slitted tube 45 within the pin electrode 104, overlying an exposed metalized surface 38 of the lead body 62, where the outer polymer coating 40 does not reside. This can be a unipolar connector or a bipolar connector, and can be the pin electrode 104 of the bipolar connector 99 of FIG. 27. The outer insulating polymer sheath 105 of the lead is not shown in this figure for the sake of clarity. The slitted tube length is such as to partially or completely fill the length of the hollow portion of the pin electrode (shown as coincident with the metallized surface 106 of the lead).

FIG. 29 is an enlarged view showing another portion of a bipolar male-type IS-1 connector such as the connector 99 of FIG. 27. The connection incorporates a slitted tube 45 within the ring electrode 107, overlying lead bodies 62 and 64. Lead body 62 has a complete outer polymer coating 40 to block electrical contact with the inner surface of the ring electrode 107, through which it passes, whereas the lead body 64 has an exposed metal surface 38 at its proximal terminus, enabling electrical contact with the ring electrode 107. Stabilization of the contact between the exposed metal surface 38 and the ring electrode 107 may be by way of laser welding, soldering, electrically conductive adhesive, or the like.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

We claim:

1. A connection on a flexible, durable fine wire electrostimulation lead formed of a drawn glass/silica fiber supporting a conductive metal layer and further including a protective outer polymer coating, the durable fine wire being suitable for implanting in the human body, comprising:
in a portion of the length of the fine wire lead, the protective outer polymer coating being removed and the conductive metal layer being exposed,
a split tube of conductive metal positioned surrounding the conductive metal layer on the fine wire lead in the portion where the outer coating has been removed, the split tube being mechanically crimped to tightly engage against the conductive metal layer to establish a good electrical conductive path between the conductive metal layer and the split tube, and
a further conductor in surrounding electrical contact with an outside surface of the split tube, the further conductor being an electrode at our near a distal end of the fine wire lead or a connector adapted to connect to an electrostimulation device, at a proximal end of the fine wire lead.

2. A connection on a fine wire lead in accordance with claim 1, wherein the further conductor comprises a connector in a male-type IS-1 protocol adapted to connect to a female-type IS-1 receiving connector on an electrostimulation device.

3. A connection on a fine wire lead in accordance with claim 1, wherein the further conductor comprises an electrostimulation electrode at or near the distal end of the fine wire lead, secured to the further conductor.

4. A connection on a fine wire lead in accordance with claim 3, wherein the electrostimulation electrode comprises a ring electrode.

5. A connection on a fine wire lead in accordance with claim 3, wherein the electrostimulation electrode comprises a mesh electrode.

6. A connection on a fine wire lead in accordance with claim 1, wherein the split tube is laser welded to the exposed conductive metal layer of the fine wire lead.

7. A connection on a fine wire lead in accordance with claim 1, wherein the fine wire lead has an outer diameter no greater than about 750 microns.

8. A connection on a flexible, durable fine wire electrostimulation leads each formed of a drawn glass/silica fiber supporting a conductive metal layer and further including a protective outer polymer coating, the durable fine wire leads being suitable for implanting in the human body, comprising:
in a portion of the length of one of the fine wire leads, the protective outer polymer coating being removed and the conductive metal layer being exposed,
a split tube of conductive metal positioned surrounding the plurality of fine wire leads and being in contact with the conductive metal layer on the one fine wire lead in the portion where the outer coating has been removed, the split tube being mechanically crimped to tightly engage against the conductive metal layer to establish a good electrical conductive path between the conductive metal layer and the split tube, and
another of said fine wire leads passing through the split tube and electrically isolated from the split tube, and
a ring electrode surrounding the split tube and electrical contact with an outside surface of the split tube.

9. A connection on a plurality of flexible, durable fine wire electrostimulation leads in accordance with claim 8, wherein the ring electrode is a part of a bipolar terminal conductor, including a male connector pin spaced from the ring electrode, the said other of the fine wire leads having its conductive metal layer connected to the male connector pin.
